(19) United States
(12) Patent Application Publication
(10) Pub. No.: US 2025/0095128 A1
(43) Pub. Date: Mar. 20, 2025

(54) LEARNING METHOD, LEARNING APPARATUS, LEARNING PROGRAM, CONTROL METHOD, CONTROL APPARATUS, AND CONTROL PROGRAM

(71) Applicant: RIKEN, Saitama (JP)

(72) Inventors: Toru UJIHARA, Aichi-ken (JP); Masaru ISONO, Aichi-ken (JP); Masaki TAKAISHI, Aichi-ken (JP); Yosuke TSUNOOKA, Aichi-ken (JP); Ichiro TAKEUCHI, Aichi-ken (JP); Kentaro KUTSUKAKE, Saitama (JP)

(21) Appl. No.: 18/815,527

(22) Filed: Aug. 26, 2024

Related U.S. Application Data
(63) Continuation of application No. PCT/JP2023/005091, filed on Feb. 15, 2023.

(30) Foreign Application Priority Data
Feb. 24, 2022 (JP) 2022-027201

(51) Int. Cl. G06T 7/00

(52) U.S. Cl. CPC G06T 7/0004; G06T 2207/10024; G06T 2207/20081; G06T 2207/30128; G06T 2207/30148

(57) ABSTRACT

A learning method includes: causing an observer to perceive information to be compared by the observer from among a plurality of pieces of perceivable information; acquiring evaluation for the information made by the observer; and rating the plurality of pieces of information based on the evaluation made by the observer for the plurality of pieces of information acquired by a plurality of repetitions of the causing the observer to perceive the information and the acquiring the evaluation.

### 1. TECHNICAL FIELD

The present disclosure relates to technology for reflecting human intentions and findings in control, etc.

### 2. DESCRIPTION OF THE RELATED ART

Silicon carbide (Sic) is attracting attention as a new material for semiconductors for power devices. The present disclosers have established technology for growing high-quality SiC crystals, and are conducting research and development for growing larger crystals for practical use (see, for example, Non-Patent Document 1).

[Non-Patent Document 1] “Making synthesis process of new materials “fully visible” with AI technology: Speeding up development speed of SiC crystals for next-generation energy-saving materials by 10 to 100 times,” https://www.nagoya-u.ac.jp/about-nu/public-relations/researchinfo/upload images/20170929_imass_1.pdf, published on Sep. 29, 2017

Since there are many parameters for controlling crystal growth, the number of combinations thereof is countless. Therefore, it is not easy to find the optimal conditions for growing larger and higher quality SiC crystals from among the combinations of these parameters.

If it is possible to construct an objective function with controllable parameters as variables, the optimal conditions can be searched for by solving an optimization problem. Experienced researchers have accumulated findings regarding the quality of conditions through repeated trial and error while changing parameters. However, it is also not easy to define an objective function that reflects the findings obtained in this way.

Such circumstances are not limited to the control of SiC crystal growth. In various fields, the craftsmanship of skilled technical experts is highly personalized and difficult to express the craftsmanship objectively using numerical values or mathematical formulas, which poses issues such as the lack of progress in inheritance of skills and automation of control.

### SUMMARY

The present invention has been made in view of the aforementioned problems, and a general purpose thereof is to provide a technology for reflecting human intentions and findings in control, etc.

A learning method according to one embodiment of

the present disclosure includes: causing an observer to perceive a plurality of pieces of perceivable information by pairwise comparison; acquiring evaluation for the information made by the observer; and rating the plurality of pieces of information by a plurality of repetitions of the causing the observer to perceive the information and the acquiring the evaluation. The pairwise comparison in the present disclosure means not only a comparison of two information, but also a comparison of three or more information.

Another embodiment of the present disclosure relates to a learning apparatus. This apparatus includes circuitry configured to: cause an observer to perceive a plurality of pieces of perceivable information by pairwise comparison; acquire evaluation for the information made by the observer; rate the plurality of pieces of information by a plurality of repetitions of the providing the information and the acquiring the evaluation; generate a latent space by dimensional compression of the plurality of pieces of information; and search for a latent variable that matches a predetermined condition in the latent space.

Still another embodiment of the present disclosure relates to a control method. This method includes: causing an observer by pairwise comparison to perceive information that expresses the state of a control target; acquiring evaluation made by the observer for information expressing the state of the control target at a first time point and information expressing the state of the control target at a second time point different from the first time point; and controlling the control target in accordance with a control parameter corresponding to a latent variable that matches a predetermined condition searched for in a latent space generated by dimensional compression of a plurality of pieces of information, the plurality of pieces of information being rated based on the evaluation.

Yet another embodiment of the present disclosure relates to a control apparatus. This apparatus includes circuitry configured to: cause an observer by pairwise comparison to perceive information that expresses the state of a control target; acquire evaluation made by the observer for information expressing the state of the control target at a first time point and information expressing the state of the control target at a second time point different from the first time point; and control the control target in accordance with a control parameter corresponding to a latent variable that matches a predetermined condition searched for in a latent space generated by dimensional compression of a plurality of pieces of information, the plurality of pieces of information being rated based on the evaluation.

Yet another embodiment of the present disclosure relates to a non-transitory recording medium having embodied thereon a learning program. This program includes computer-implemented modules including: a module that causes an observer to perceive a plurality of pieces of perceivable information by pairwise comparison; a module that acquires evaluation for the information made by the observer; a module that rates the plurality of pieces of information by a plurality of repetitions of the providing the information and the acquiring the evaluation; a module that generates a latent space by dimensional compression of the plurality of pieces of information; and a module that searches for a latent variable that matches a predetermined condition in the latent space.

Still another embodiment of the present disclosure relates to a non-transitory recording medium having embodied thereon a control program. This program includes computer-implemented modules including: a module that causes an observer by pairwise comparison to perceive information that expresses the state of a control target; a module that acquires evaluation made by the observer for information expressing the state of the control target at a first time point and information expressing the state of the control target at a second time point different from the first time point; and a module that controls the control target in accordance with a control parameter corresponding to a latent variable that matches a predetermined condition searched for in a latent space generated by dimensional compression of a plurality of pieces of information, the plurality of pieces of information being rated based on the evaluation.

Optional combinations of the aforementioned constituting elements and implementations of the present disclosure in the form of methods, apparatuses, systems, recording mediums, and computer programs may also be practiced as additional modes of the present disclosure.

### BRIEF DESCRIPTION OF THE DRAWINGS

FIG. 1 is a diagram showing the configuration of a crystal production system for producing SiC crystals;

FIG. 2 is a diagram showing an example of the temperature distribution and flow distribution of high-temperature liquid metal in a crucible;

FIG. 3 is a diagram showing examples of images that are presented to an operator;

FIG. 4 is a diagram showing the concept of a variational autoencoder;

FIG. 5 is a diagram showing an example of a latent space generated by a variational autoencoder:

FIGS. 6A and 6B are diagrams in which scores of images are plotted;

FIGS. 7A and 7B are diagrams showing an example of a latent space generated by a variational autoencoder and examples of images arranged closely in the latent space;

FIG. 8 is a flowchart showing a procedure of a learning method according to an embodiment;

FIG. 9 is a flowchart showing a procedure of a control method according to the embodiment;

FIG. 10 is a diagram showing a configuration of a learning apparatus according to an embodiment of the present disclosure;

FIGS. 11A and 11B show examples of results of analysis performed by a decision basis analysis unit;

FIGS. 12A, 12B, and 12C are diagrams showing examples of results of dividing images into three sets according to scores followed by analysis performed by the decision basis analysis unit for each of the sets;

FIG. 13 is a diagram showing a configuration of a control apparatus according to an embodiment of the present disclosure;

FIG. 14 is a diagram showing an example of an image with a high score among images rated by the learning apparatus according to the embodiment;

FIG. 15 is a diagram showing the optimal temperature and flow distributions obtained by the learning apparatus according to the embodiment;

FIGS. 16A and 16B are diagrams showing SiC crystals produced by a crystal production apparatus according to the embodiment; and

FIG. 17 is a diagram showing examples of an image that is presented to an operator.

### DETAILED DESCRIPTION

The invention will now be described by reference to the preferred embodiments. This does not intend to limit the scope of the present invention, but to exemplify the invention.

As an embodiment of the present disclosure, an explanation will be given of technology that enables quantification of human intentions and findings and automatic search for the optimal one. As an example, a case will be explained where conditions for producing SiC crystals are optimized.

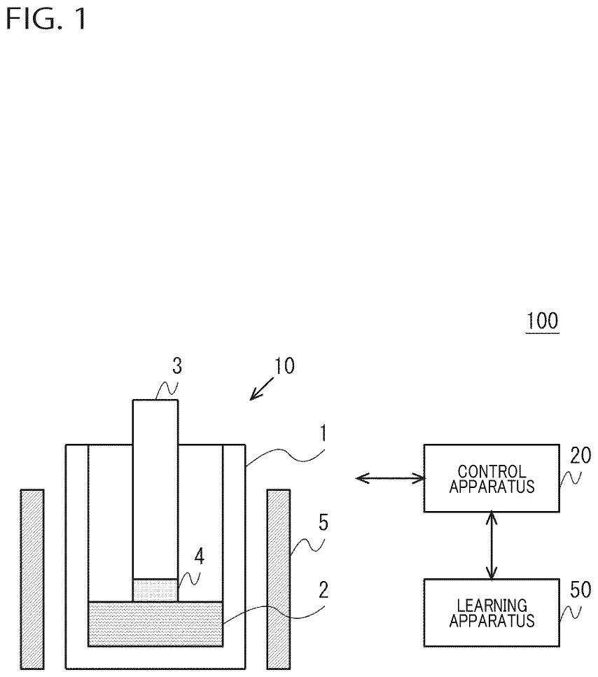

FIG. 1 is a diagram showing the configuration of a crystal production system for producing SiC crystals. The crystal production system 100 includes a crystal production apparatus 10, a control apparatus 20, and a learning apparatus 50. Arrows in the figure represent flows of information, and the operator operates the crystal production system 100 via the control apparatus 20.

The crystal production apparatus 10 includes a carbon crucible 1, a carbon stick 3, and a heating coil 5. The crucible 1 accommodates a high-temperature liquid metal 2 that serves as a raw material. The carbon stick 3 allows a SiC crystal to grow at the tip thereof. The heating coil 5 heats the crucible 1. The crystal production apparatus 10 also includes a structure that is not shown in the figure for rotating or moving the crucible 1, the carbon stick 3, and the heating coil 5.

The control apparatus 20 controls the conditions for growing SiC crystals in the crystal production apparatus 10. The control apparatus 20 controls the rotation and movement of the crucible 1, the carbon stick 3, and the heating coil 5 at least either before or during the growth of a SiC crystal. Further, the control apparatus 20 controls current flowing through the heating coil 5, the position of the heating coil 5, etc., such that the inside of the crucible 1 reaches a set temperature.

The operator puts a predetermined amount of the high-temperature liquid metal 2 inside the crucible 1 having a cylindrical shape and sets a seed crystal at the tip of the carbon stick 3. The control apparatus 20 moves the carbon stick 3 so as to immerse the tip into the high-temperature liquid metal 2 and heats the inside of the crucible 1 to the set temperature by applying current to the heating coil 5. This causes a SiC crystal 4 to grow at the tip of the carbon stick 3.

The control apparatus 20 predicts or observes the temperature distribution and flow distribution of the high-temperature liquid metal 2 in the crucible 1 while the SiC crystal is growing, and presents a visualized image of the temperature distribution and flow distribution of the high-temperature liquid metal 2 to the operator. While viewing the temperature distribution and flow distribution of the high-temperature liquid metal 2, the operator inputs instructions to the control apparatus 20 regarding rotation and movement of the crucible 1, the carbon stick 3, and the heating coil 5, the set temperature, etc., in order to produce a larger and higher quality SiC crystal.

The learning apparatus 50 searches for optimal conditions for growing SiC crystals in the crystal production apparatus 10. In the present embodiment, the learning apparatus 50 optimizes the conditions defined by seven control parameters: the rotation speed of the seed crystal; the rotation speed of the crucible 1; the relative position of the crucible 1 and the coil; the position of the coil; the level of the high-temperature liquid metal 2; the level of the meniscus of the high-temperature liquid metal 2; and the set temperature.

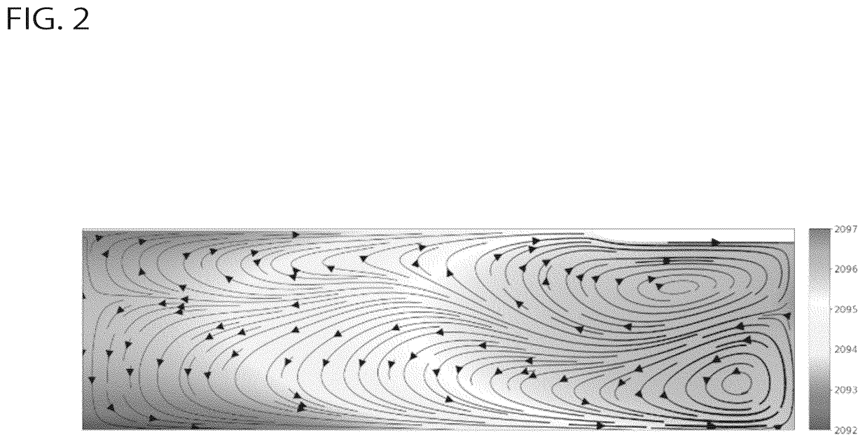

FIG. 2 shows an example of the temperature distribution and flow distribution of the high-temperature liquid metal 2 in the crucible 1. As described in Non-Patent Document 1, the invention by the present disclosers allows the temperature distribution and flow distribution of the high-temperature liquid metal 2 in the crucible 1 to be predicted and visualized in real time, allowing the operator to control the conditions by inputting instructions to the control apparatus 20 while looking at the high-temperature liquid metal 2 in the crucible 1.

Experienced operators have findings regarding the temperature distribution and flow distribution for obtaining large and high-quality SiC crystals, and based on these findings, it is possible to suitably control the temperature distribution and flow distribution of the solution in the crucible 1 while growing SiC crystals, allowing for the growth of large and high-quality SiC crystals.

However, it is difficult to precisely express all of those findings in numerical values or mathematical formulas. Further, even if those findings are partially expressed in numerical values or mathematical formulas, it is impossible to reflect the tacit knowledge, which is difficult to express objectively, in numerical values or mathematical formulas.

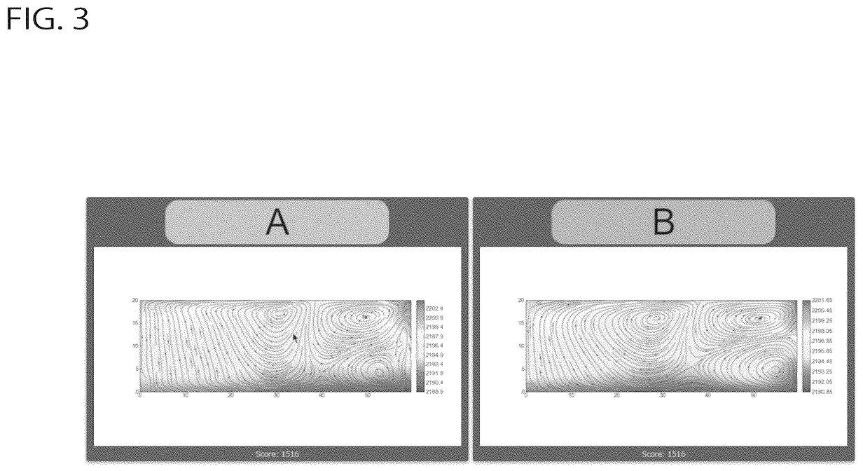

In order to solve these problems, the learning apparatus 50 according to the present embodiment prepares many images representing the temperature distribution and flow distribution of the high-temperature liquid metal 2 in the crucible 1 under different conditions, selects two images each from those images, and presents the images to the operator as shown in FIG. 3, for example, and then asks which of the images the operator thinks is most suitable in order to obtain larger and higher quality SiC crystals. In an exemplary embodiment described below, 200 to 300 pairs of two images were evaluated. Such evaluation itself is known as a paired comparison method, in which two samples among a large number of samples are compared in pairs without evaluating the samples all at once. This time, as a result of ingenuity and careful consideration, the inventors have discovered that the use of the paired comparison method is the optimal means for learning skilled engineers' findings and tacit knowledge. The learning apparatus 50 assigns a score to each of the prepared images based on the results of the quality evaluation acquired from the operator. This allows for the generation of an objective function for optimizing the conditions for growing SiC crystals.

Elo rating is a suitable method for assigning a score to each image based on the result of the quality evaluation performed by the operator. Elo rating is used in competitive games, such as chess, as an indicator for expressing competence by relative evaluation. The learning apparatus 50 sets an initial value for the rating of each image and updates the rating value each time the image is evaluated by an operator. The learning apparatus 50 compares the quality probability calculated based on the respective rating values of the two images and the actual evaluation results, and updates the respective rating values based on the difference. Through repeated evaluation by the operator, the rating value of each of the images gradually converges to a value that reflects the actual relative evaluation.

It is difficult and impractical for the operator to determine the order of the quality and the absolute value of the score of each image after comprehensively keeping track of a large number of images; however, quality evaluation through the comparison of two images is relatively easy. By obtaining the operator's evaluation through a method of repeating the comparison of two images, the operator's intentions and findings can be more accurately quantified. In addition, findings and the like that the operator is not aware of or cannot clearly express can be reflected in numerical values.

In some fields, once a large amount of information expressing the state of a control target or the like is rated as described above, all that is left may be to simply achieve the state with the highest score; however, this may not always be the case. In the crystal production apparatus 10 according to the present embodiment, since it is necessary to achieve outward and inward flows of the high-temperature liquid metal 2 when growing SiC crystals, it is necessary to select outward and inward flows as the optimal temperature and flow distributions, respectively. In this case, among the seven control parameters mentioned above, the position of the crucible 1, the position of the heating coil 5, the level of the high-temperature liquid metal 2, and the set temperature cannot be changed midway, and there is therefore a constraint that similar values must be selected. As described, if there are any constraints or the like in selecting the optimal solution, the learning apparatus 50 performs optimization of an objective function in which rating has been performed and scores have been assigned as described above.

As a learning model for obtaining the optimal solution that matches the operator's intentions and sense from images and score information obtained through a paired comparison method, the inventor's ingenuity and consideration have led to the use of a variational auto-encoder (VAE) from among various deep learning models.

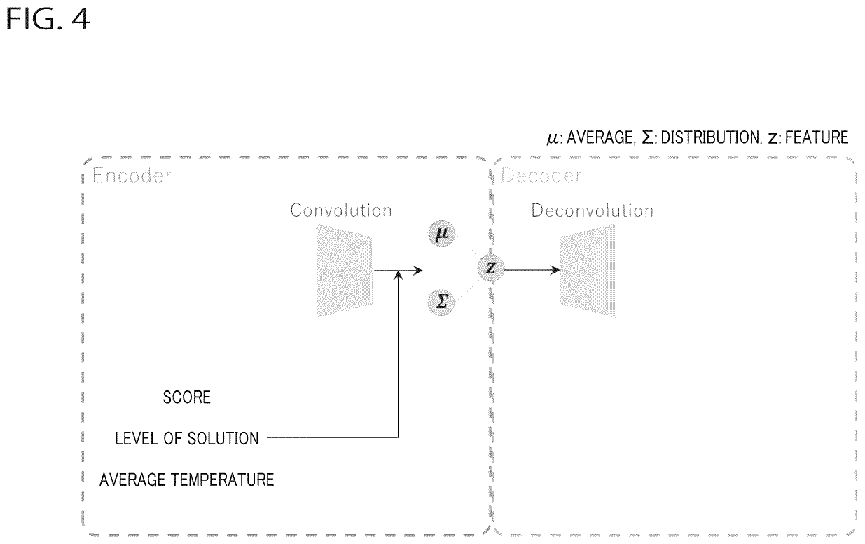

FIG. 4 shows the concept of a variational autoencoder. In an encoder unit of a variational autoencoder, a high-dimensional image is compressed to have a low-dimensional feature. Since the conditions defined by the seven control parameters are optimized in the present embodiment, compression into a feature of seven dimensions or less is desirable. In the decoder unit, the high-dimensional image is restored from the low-dimensional feature. In a semi-supervised variational autoencoder, a score assigned to the image may be used as a label. In this case, a latent space can be generated such that images with similar scores are placed close to one another.

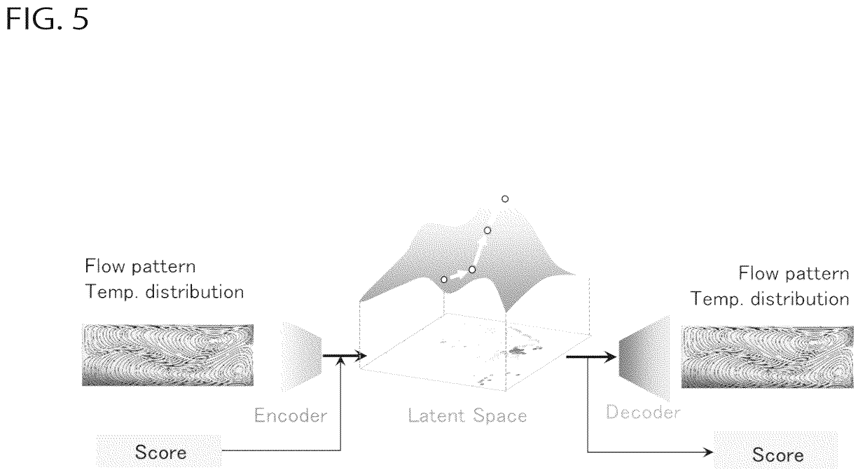

FIG. 5 shows an example of a latent space generated by a variational autoencoder. In FIG. 5, scores corresponding to respective latent variables in a seven-dimensional latent space are schematically depicted as surfaces in a three-dimensional space. The learning apparatus 50 can search for a latent variable with the largest score in the latent space. Further, the learning apparatus 50 can also search for a path that transitions from a low-scoring state to a high-scoring state in the latent space.

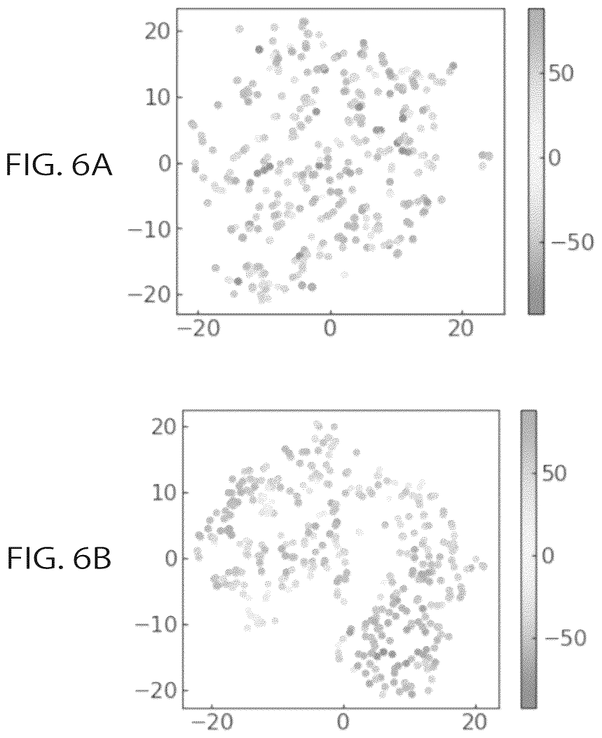

FIG. 6A shows plotting of the scores of the respective images in a coordinate plane in which the seven-dimensional space of the above-described parameters (the rotation speed of the seed crystal, the rotation speed of the crucible 1, the relative position of the crucible 1 and the coil, the position of the coil, the level of the high-temperature liquid metal 2, the level of the meniscus of the high-temperature liquid metal 2, and the set temperature) has been dimensionally compressed into a two-dimensional space. In a control parameter space, the distribution of the image scores is scattered. FIG. 6B shows plotting of the scores in a coordinate plane in which a seven-dimensional space with image data compressed dimensionally by a semi-supervised variational autoencoder using the scores has been further compressed dimensionally into a two-dimensional space. The semi-supervised variational autoencoder constructs a latent space such that images with similar scores are placed close to one another. Therefore, rather than searching for the optimal solution in the control parameter space, searching for the optimal solution in the latent space makes it possible to obtain the optimal solution that is more suitable for the operator's intentions and sense.

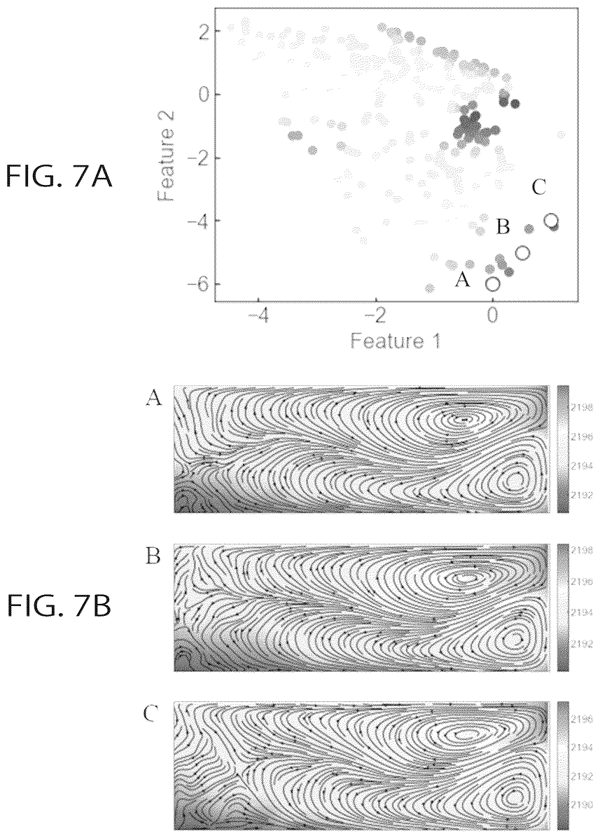

FIG. 7A shows plotting of the scores in a coordinate plane in which a seven-dimensional space with image data compressed dimensionally by a semi-supervised variational autoencoder using the scores has been further compressed dimensionally into a two-dimensional space. FIG. 7B shows images corresponding to A, B, and C in FIG. 7A. It can be found that the flow and temperature distributions of images A, B, and C, which are placed closely in a latent space generated by the semi-supervised variational autoencoder, are similar.

The learning apparatus 50 generates the latent space by dimensionality compressing the images with the semi-supervised variational autoencoder using scores. The learning apparatus 50 learns a model that predicts latent variables from control parameters based on the correspondence between the values of control parameters corresponding to the respective images and the values of latent variables in the latent space. For example, a model may be learned in which the values of the control parameters are input to an input layer of a neural network and the values of the latent variables are output from an output layer.

In the generated latent space, under the constraints of fixing the position of the crucible 1, the position of the heating coil 5, the level of the high-temperature liquid metal 2, and the set temperature, the learning apparatus 50 searches for a latent variable with a high score for each of the outward flow and the inward flow using an algorithm such as a genetic algorithm. The learning apparatus 50 outputs control parameters corresponding to the latent variables that have been searched for to the control apparatus 20.

The control apparatus 20 controls the crystal production apparatus 10 using the control parameters obtained from the learning apparatus 50. This allows for the achievement of ideal temperature and flow distributions for the high-temperature liquid metal 2 that reflect the operator's intentions and findings, thus allowing for the growth of larger and higher quality SiC crystals.

If the temperature or flow distribution of the high-temperature liquid metal 2 deviates from the ideal state due to some factor while growing a SiC crystal, the control apparatus 20 may instruct the learning apparatus 50 to search for the optimal control to restore the ideal state. The learning apparatus 50 acquires images visualizing the current temperature and flow distributions of the high-temperature liquid metal 2 from the control apparatus 20 and converts the acquired images to latent variables through dimensional compression. The learning apparatus 50 determines a path for changing the current latent variables to the optimal latent variables in the latent space under the above constraints, converts the path into control parameters, and outputs the control parameters to the control apparatus 20. The control apparatus 20 controls the crystal production apparatus 10 using the control parameters obtained from the learning apparatus 50. Thereby, the ideal temperature and flow distributions for the high-temperature liquid metal 2 can be achieved.

The control and the learning may be performed in parallel while a SiC crystal is being grown by the crystal production apparatus 10. While looking at the visualized images of temperature and flow distributions presented chronologically, the operator compares past images with the current images so as to evaluate whether they are the quality. The operator may be presented with images of predicted future temperature and flow distributions of the high-temperature liquid metal 2 and compare the images with the current images. The learning apparatus 50 obtains the operator's evaluation and rates each of the compared images. This allows the rating of the images to be updated in real time during crystal production. If the temperature and flow distributions are rated as becoming worse, the learning apparatus 50 searches for latent variables in the latent space that are for achieving temperature and flow distributions with higher scores and outputs the corresponding control parameters to the control apparatus 20. If the temperature and flow distributions are rated as becoming better, the learning apparatus 50 does not have to perform optimization, and may search for latent variables in the latent space that are for achieving temperature and flow distributions with even higher scores and output the corresponding control parameters to the control apparatus 20. Such technology allows the operator to grow larger and higher quality SiC crystals simply by evaluating the quality while looking at visualized images of temperature and flow distributions.

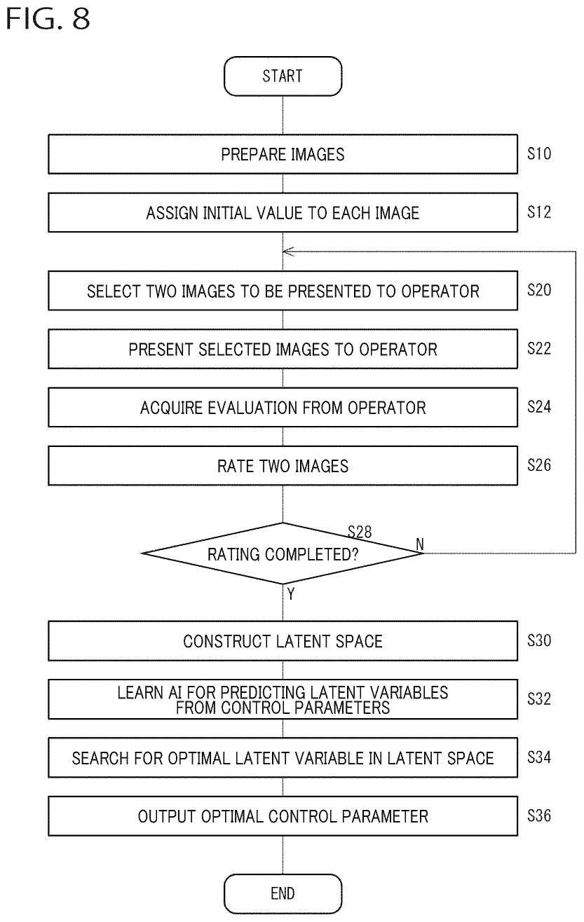

FIG. 8 is a flowchart showing a procedure of a learning method according to the embodiment.

In step S10, the learning apparatus 50 prepares images visualizing the temperature and flow distributions of the high-temperature liquid metal 2 in the crucible 1 under a large number of different conditions. These images may be generated through prediction of the temperature and flow distributions of the high-temperature liquid metal 2 in the crucible 1 or may be acquired from those observed when actually growing a SiC crystal.

In step S12, the learning apparatus 50 assigns an initial score value to all images. When Elo rating is used, the initial score value may be, for example, 1500.

In step S20, the learning apparatus 50 selects two images to be compared by the operator. The learning apparatus 50 may select the images in descending order of score (rating value) or may randomly select images. The learning apparatus 50 may select images from a set of images that are representative of similar images. For example, the learning apparatus 50 may divide the latent space into meshes and select representative images from each mesh. The learning apparatus 50 may select images from a set after screening images based on scores or the like. For example, the learning apparatus 50 may divide the images into multiple sets based on scores and select images from the same set. The learning apparatus 50 may perform Bayesian optimization for the purpose of obtaining high scores in the latent space. The learning apparatus 50 may select images based on an orthogonal table. For example, the learning apparatus 50 may divide the latent space into meshes and select images that correspond to grid points. The learning apparatus 50 may select three or more images.

In step S22, the learning apparatus 50 presents the images selected in step S20 to the operator. The learning apparatus 50 may present two images or three or more images at the same time, or may present multiple images in chronological order. The learning apparatus 50 may present the images along with a reference image serving as a basis for decision making. The learning apparatus 50 may present the selected images with random perturbations.

In step S24, the learning apparatus 50 obtains evaluation from the operator. The learning apparatus 50 may obtain the evaluation through input to an input apparatus, or through the operator's voice, movements, facial expressions, line of sight, and the like.

In step S26, the learning apparatus 50 updates the ratings of the two images presented to the operator based on the evaluation acquired from the operator. The learning apparatus 50 may rate the images by Elo rating or by any other rating technique. The learning apparatus 50 may allow manual score modification for individual images.

The learning apparatus 50 repeats steps S20 through S26 until the rating of all images is completed (N in S28). When the rating of all the images is completed (Y in S28), the process proceeds to step S30.

In step S30, the learning apparatus 50 constructs a latent space by dimensional compression of the images. The method for constructing the latent space may be the conditional variational autoencoder described above, or may be variational autoencoder, principal component analysis, singular value decomposition, eigen decomposition method, QZ decomposition method, Takagi decomposition method, non-negative matrix factorization, T-SNE, U-MAP, multi-dimensional scaling, locally linear embedding (LLE), ISOMAP, Laplacian Eigenmap, etc. The latent space is desirably constructed by a method such as coordinate transformation, dimensional compression, or the like such that images with similar scores are placed close to one another and images with significantly different scores are placed far apart.

In step S32, the learning apparatus 50 learns AI for predicting latent variables from control parameters.

In step S34, the learning apparatus 50 searches for the optimal latent variable in the latent space.

In step S36, the learning apparatus 50 outputs control parameters corresponding to the latent variables that have been searched for to the control apparatus 20.

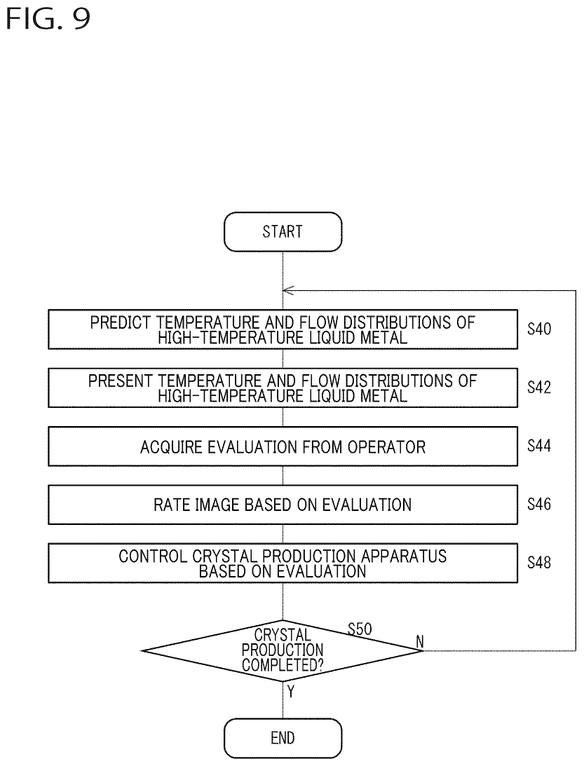

FIG. 9 is a flowchart showing the procedure of the control method.

In step S40, the control apparatus 20 predicts the temperature and flow distributions of the high-temperature liquid metal 2.

In step S42, the control apparatus 20 presents the predicted temperature and flow distributions of the high-temperature liquid metal 2.

In step S44, the control apparatus 20 obtains operator's evaluation that compares past and current images of the temperature and flow distributions of the high-temperature liquid metal 2.

In step S46, the learning apparatus 50 rates the past and current images of the high-temperature liquid metal 2 based on the operator's evaluation.

In step S48, the control apparatus 20 controls the crystal production apparatus 10 such that ideal temperature and flow distributions of the high-temperature liquid metal 2 are realized based on the operator's evaluation.

Steps S40 through S48 are repeated until crystal production by the crystal production apparatus 10 is completed (N in S50). When the crystal production by the crystal production apparatus 10 is completed (Y in S50), the control method is ended.

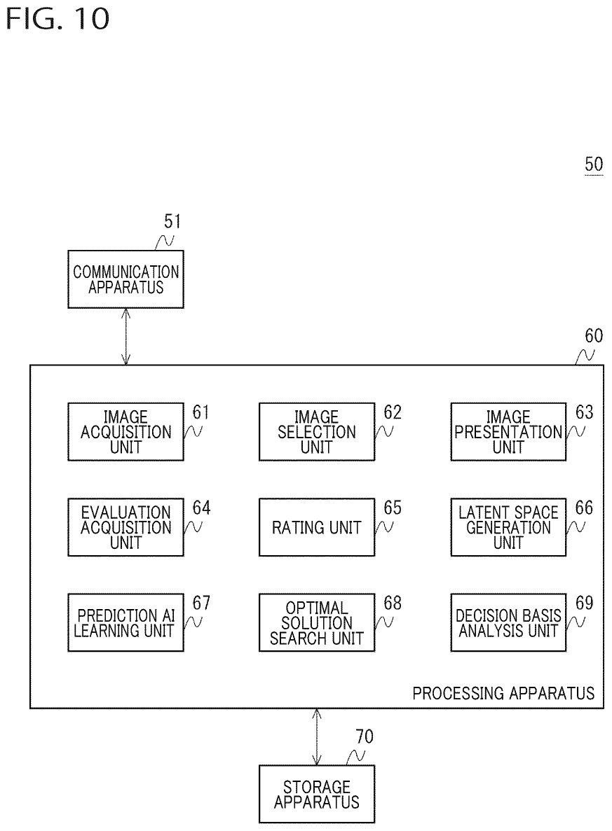

FIG. 10 shows the configuration of a learning apparatus 50 according to an embodiment of the present disclosure. The learning apparatus 50 includes a communication apparatus 51, a storage apparatus 70, and a processing apparatus 60. The learning apparatus 50 may be a server apparatus, an apparatus such as a personal computer, or a portable terminal such as a cell phone terminal, a smart phone, a tablet terminal, or the like.

The communication apparatus 51 controls communication with other apparatuses. The communication apparatus 51 may communicate by any wired or wireless communication method.

The storage apparatus 70 stores programs, data, etc., used by the processing apparatus 60. The storage apparatus 70 may be a semiconductor memory, a hard disk, or the like.

The processing apparatus 60 includes an image acquisition unit 61, an image selection unit 62, an image presentation unit 63, an evaluation acquisition unit 64, a rating unit 65, a latent space generation unit 66, a prediction AI learning unit 67, an optimal solution search unit 68, and a decision basis analysis unit 69. The configuration is implemented in hardware by any circuit (circuitry), a CPU of a computer, memory, other LSI's, or the like and in software by a program or the like loaded into the memory. FIG. 3 depicts functional blocks implemented by the cooperation of hardware and software. Thus, a person skilled in the art should appreciate that there are many ways of accomplishing these functional blocks in various forms in accordance with the components of hardware only or the combination of hardware and software.

The image acquisition unit 61 acquires images visualizing the temperature and flow distributions of the high-temperature liquid metal 2 in the crucible 1 under a large number of different conditions.

The image selection unit 62 selects two images to be compared by an operator. The image presentation unit 63 presents the images selected by the image selection unit 62 to the operator. The evaluation acquisition unit 64 acquires evaluation from the operator. The rating unit 65 updates the ratings of the two images presented to the operator based on the evaluation acquired from the operator.

The latent space generation unit 66 constructs the latent space by dimensional compression of the images. The prediction AI learning unit 67 learns AI for predicting latent variables from control parameters.

The optimal solution search unit 68 searches for the optimal latent variable in the latent space. The optimal solution search unit 68 outputs control parameters corresponding to the latent variables that have been searched for to the control apparatus 20.

The decision basis analysis unit 69 analyzes which part of an image the operator placed importance on when evaluating the image. The decision basis analysis unit 69 learns a model to predict a score from a rated image. For example, the decision basis analysis unit 69 may learn a model in which an image is input to an input layer of a neural network and in which a score is output from an output layer. The decision basis analysis unit 69 may acquire the gradient of the last convolutional layer in the neural network that has the most influence on the score prediction, using a method such as gradient-weighted class activation mapping (Grad-CAM), and may visualize the part of the image on which the operator placed importance.

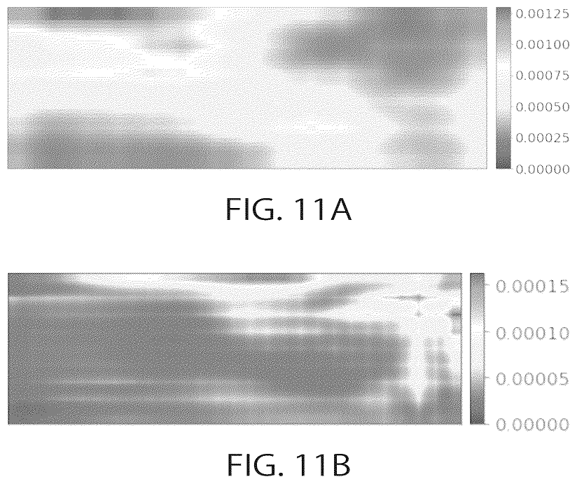

FIGS. 11A and 11B show examples of results of analysis performed by the decision basis analysis unit 69. FIG. 11A shows the results of analyzing data obtained at the time of acquiring operator's evaluation in order to obtain optimal conditions for producing three-inch SiC crystals. FIG. 11B shows the results of analyzing data obtained at the time of acquiring the operator's evaluation in order to obtain optimal conditions for an outward flow for producing six-inch SiC crystals. It can be found that the upper part is given importance in both cases and that the side part is also given importance in the case of the six-inch ones.

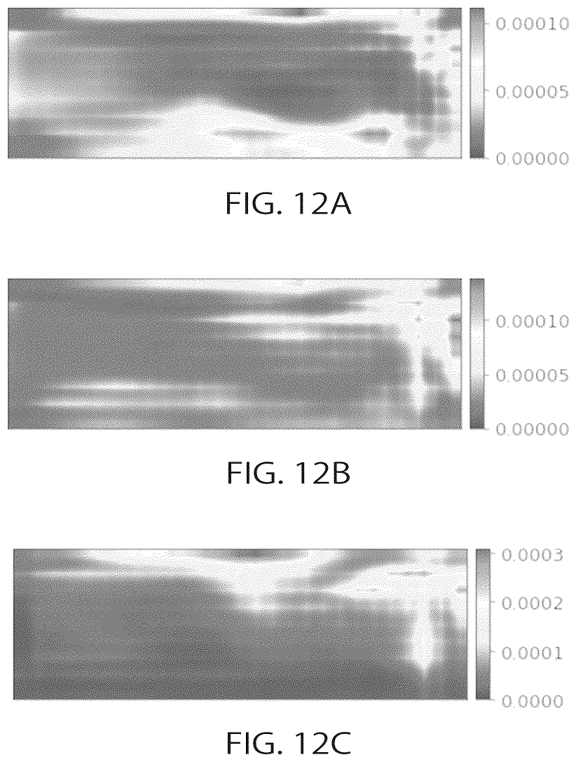

FIGS. 12A, 12B, and 12C show examples of results of dividing images into three sets according to scores followed by analysis performed by the decision basis analysis unit 69 for each of the sets. FIG. 12A shows the results for a set in the top one-third, FIG. 12B shows the results for a set in the middle one-third, and FIG. 12C shows the results for a set in the bottom on-third. In the middle and bottom sets, importance is placed on the crystal surface and near the walls of crucible 1. Further, in the upper set, importance is placed on the bottom part of the crucible 1.

By checking the results of the analysis by the decision basis analysis unit 69 with the operator, it is possible to confirm that the rating has been performed correctly. Further, the operator can be provided with useful information for the operator to manually control the crystal production apparatus 10.

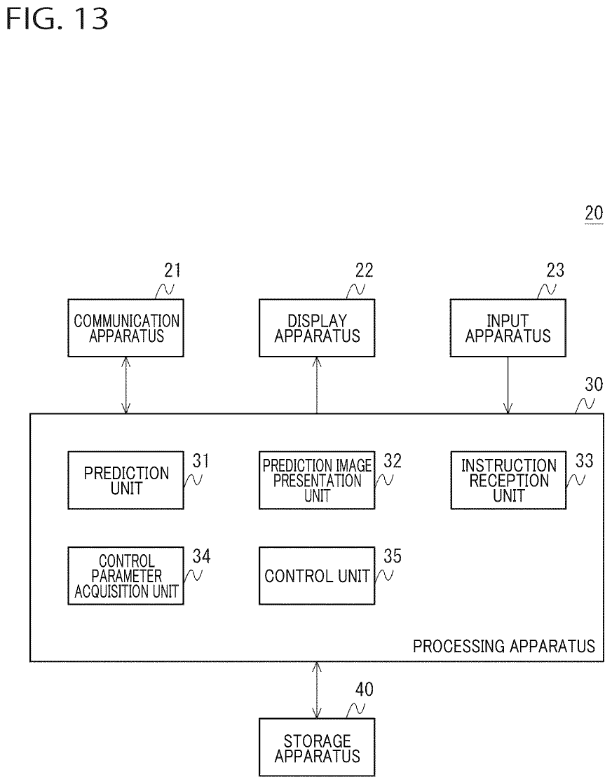

FIG. 13 shows the configuration of a control apparatus 20 according to the embodiment of the present disclosure. The control apparatus 20 includes a communication apparatus 21, a display apparatus 22, an input apparatus 23, a storage apparatus 40, and a processing apparatus 30. The control apparatus 20 may be a server apparatus, an apparatus such as a personal computer, or a portable terminal such as a cell phone terminal, a smart phone, a tablet terminal, or the like.

The communication apparatus 21 controls communication with other apparatuses. The communication apparatus 21 may communicate by any wired or wireless communication method. The display apparatus 22 displays a screen generated by the processing apparatus 30. The display apparatus 22 may be a liquid crystal display apparatus, an organic EL display apparatus, or the like. The input apparatus 23 transmits instruction input from the operator to processing apparatus 30. The input apparatus 23 may be a mouse, a keyboard, a touchpad, or the like. The display apparatus 22 and the input apparatus 23 may be implemented as a touch panel. The storage apparatus 40 stores programs, data, etc., used by the processing apparatus 30. The storage apparatus 40 may be a semiconductor memory, a hard disk, or the like.

The processing apparatus 30 includes a prediction unit 31, a prediction image presentation unit 32, an instruction reception unit 33, a control parameter acquisition unit 34, and a control unit 35. The configuration is implemented in hardware by any CPU of a computer, memory, other LSI's, or the like and in software by a program or the like loaded into the memory. The figure depicts functional blocks implemented by the cooperation of hardware and software. Thus, a person skilled in the art should appreciate that there are many ways of accomplishing these functional blocks in various forms in accordance with the components of hardware only or the combination of hardware and software.

The prediction unit 31 predicts the temperature and flow distributions of the high-temperature liquid metal 2. The prediction image presentation unit 32 displays the temperature and flow distributions of the high-temperature liquid metal 2 predicted by the prediction unit 31 on the display apparatus 22.

The instruction reception unit 33 receives an instruction from the operator through the input apparatus 23 or the like. The control parameter acquisition unit 34 acquires the value of the optimal control parameter from the learning apparatus 50. The control unit 35 controls the crystal production apparatus 10 in accordance with the instruction received by the instruction reception unit 33 and the control parameter acquired by the control parameter acquisition unit 34.

The learning apparatus 50 may function as a part of the control apparatus 20. In other words, while growing a SiC crystal, the evaluation acquisition unit 64 of the learning apparatus 50 may acquire the evaluation performed by the operator looking at the image presented by the prediction image presentation unit 32, the rating unit 65 may rate the image, and the optimal solution search unit 68 may search for optimal control parameters and notify the control apparatus 20 of the optimal control parameters. When the control parameter acquisition unit 34 acquires the control parameters from the learning apparatus 50, the control unit 35 controls the crystal production apparatus 10 in accordance with the control parameters. This allows the crystal production apparatus 10 to be automatically controlled while updating the rating of the image.

### Exemplary Embodiment

Three operators were presented with images visualizing the temperature and flow distributions of the high-temperature liquid metal 2 so as to acquire evaluation, and the images were rated and averaged. In order to verify the accuracy of the rating, two images were selected from the rated images such that the difference in score is equal to or greater than a certain value and were presented to the operators, and the images were tested to see if the image with the higher score was evaluated as better. Two operators were given the test 200 times each, and the correct answer rate was 95% or more. The scores were used to search for optimal conditions for growing SiC crystals.

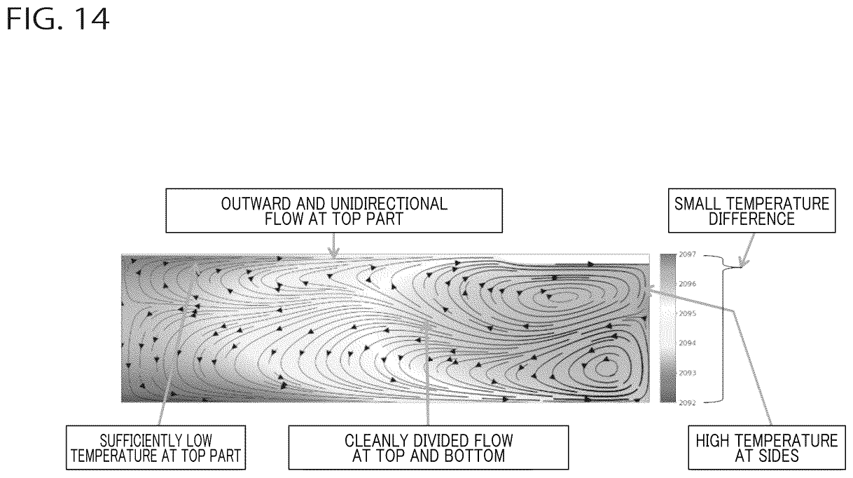

FIG. 14 shows an example of an image with a high score among images rated by the learning apparatus 50. It is confirmed that high scores are assigned to images with suitable temperature and flow distribution characteristics, such as having a small temperature difference between the top and the bottom, having some areas with sufficiently low temperature at the top part, having some areas with high temperature at the sides, having an outward and unidirectional flow at the top part, and having a cleanly divided flow at the top and the bottom.

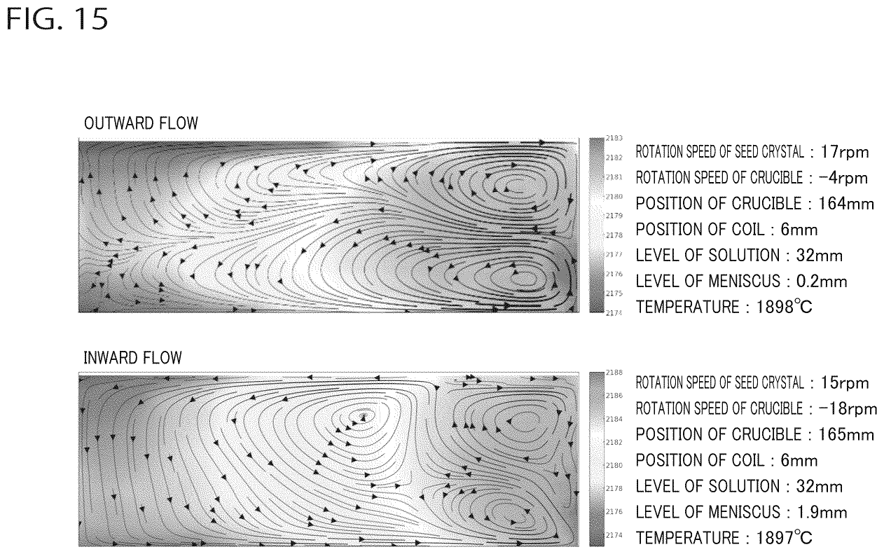

FIG. 15 shows the optimal temperature and flow distributions obtained by the learning apparatus 50 according to the embodiment. The ideal temperature and flow distribution conditions, which reflect the operator's intentions and findings, were able to be obtained in a short period of time.

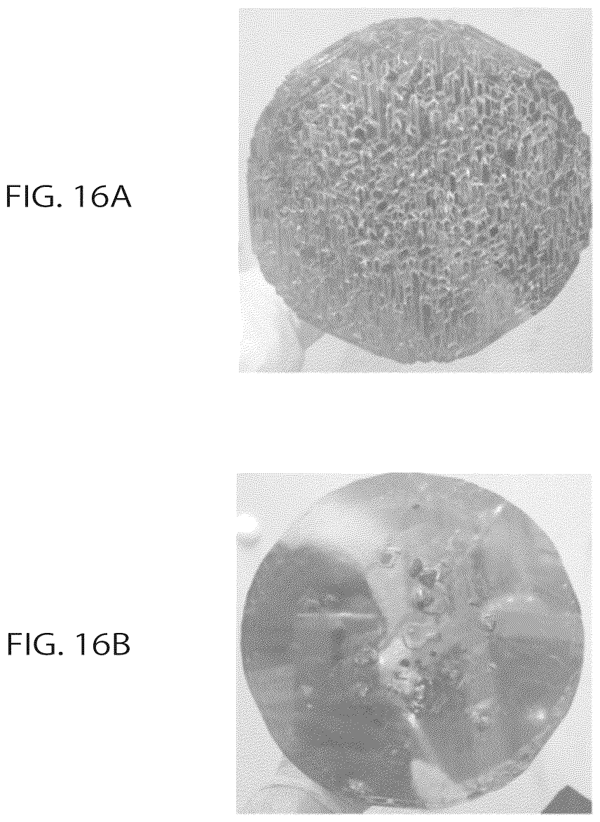

FIGS. 16A and 16B show SiC crystals produced by a crystal production apparatus 10 according to the embodiment. FIG. 16A shows a SiC crystal produced under conventional experimental conditions. The surface of the crystal is rough. FIG. 16B shows a SiC crystal produced under the optimal conditions shown in FIGS. 11A and 11B. The thickness is 1.7 mm to 2.6 mm. It has been shown that since the surface of the crystal is smooth and stable growth over a long period of time is possible, it is possible to produce larger and higher quality SiC crystals.

Described above is an explanation on the present disclosure based on the embodiment. This embodiment is intended to be illustrative only, and it will be obvious to those skilled in the art that various modifications to constituting elements and processes could be developed and that such modifications are also within the scope of the present disclosure.

In the embodiment, multiple images are presented to the operator for comparison; however, the information provided to the observer may be any kind of information that can be perceived by the observer using five senses, such as moving images, text, symbols, sounds, smells, tastes, etc.

In the embodiments, the case of rating images related to the production of SiC crystals is described. The technology according to the present disclosure can be used for rating moving images related to the production of SiC crystals, images or moving images related to the production of other semiconductor crystal materials, images or moving images related to the production of other crystal materials, or images or moving images related to the production of other materials. The images related to the production of materials may be, for example, pattern images of material temperature, flow, density, etc., crystal surface pictures, crystal surface microscope images, crystal shape images, wave pattern images, etc.

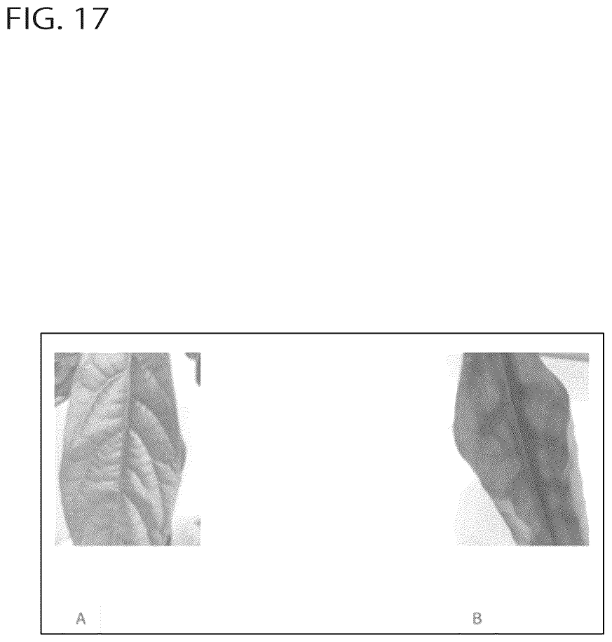

The technology according to the present disclosure are also applicable to rating other images, for example. The other images may be, for example, color pictures of agricultural crops or printed pattern images. FIG. 17 shows examples of color pictures of an agricultural crop presented to an operator. The image selection unit 62 of the learning apparatus 50 selects two pictures to be compared by the operator from among a large number of color pictures of an agricultural crop. The image presentation unit 63 presents the color pictures of the agricultural crop selected by the image selection unit 62 to the operator. The evaluation acquisition unit 64 acquires evaluation from the operator regarding the quality of the taste, grade, and growth of the agricultural crop. The rating unit 65 updates the ratings of the two color pictures of the agricultural crop presented to the operator based on the evaluation acquired from the operator. Each of the color pictures of the agricultural crop may be associated with the growth conditions of the agricultural crop. The latent space generation unit 66 constructs a latent space by dimensional compression of the color pictures of the agricultural crop. The prediction AI learning unit 67 learns AI for predicting latent variables from the growth conditions of the agricultural crop. The optimal solution search unit 68 searches for the optimal latent variable in the latent space.

The optimal solution search unit 68 outputs the growth conditions corresponding to the latent variables that have been searched for. This allows for the acquisition of suitable growth conditions for the agricultural crop.

The control apparatus 20 or the learning apparatus 50 may be realized as a server apparatus, and the crystal production apparatus 10 may be realized as a client terminal. The learning apparatus 50 may be realized as a server apparatus, and the control apparatus 20 may be realized as a client terminal. The server apparatus may be realized by multiple apparatuses, and the multiple apparatuses may be provided by multiple entities. The functions of the control apparatus 20 or the learning apparatus 50 may be distributed across multiple apparatuses. A portion of the functions of the control apparatus 20 or the learning apparatus 50 may be provided in the crystal production apparatus 10.

1. A learning method comprising:
causing an observer to perceive a plurality of pieces of perceivable information by pairwise comparison;
acquiring evaluation for the information made by the observer;
rating the plurality of pieces of information by a plurality of repetitions of the causing the observer to perceive the information and the acquiring the evaluation;
generating a latent space by dimensional compression of the plurality of pieces of information; and
searching for a latent variable that matches a predetermined condition in the latent space.

2. The learning method according to claim 1, wherein
the rating the plurality of pieces of information includes rating the plurality of pieces of information by Elo rating.

3. The learning method according to claim 1, wherein
the generating the latent space includes generating a latent space by dimensional compression of the plurality of pieces of information such that similar information is closely placed.

4. The learning method according to claim 3, wherein
the generating the latent space includes generating the latent space by a variational autoencoder using a score assigned to each of the plurality of pieces of information in the rating.

5. The learning method according to claim 3, wherein
the searching includes searching for a latent variable with the largest score.

6. The learning method according to claim 1, wherein
the information represents an image or a moving image.

7. The learning method according to claim 6, wherein
the information represents an image related to the production of a material.

8. The learning method according to claim 7, wherein
the information represents an image visualizing temperature and flow distributions of a raw material for producing the material.

9. The learning method according to claim 8, wherein
the material is a SiC crystal.

10. A learning apparatus comprising circuitry configured to:
cause an observer to perceive a plurality of pieces of perceivable information by pairwise comparison;
acquire evaluation for the information made by the observer;
rate the plurality of pieces of information by a plurality of repetitions of the providing the information and the acquiring the evaluation;
generate a latent space by dimensional compression of the plurality of pieces of information; and
search for a latent variable that matches a predetermined condition in the latent space.

11. A control method comprising:
causing an observer by pairwise comparison to perceive information that expresses the state of a control target;
acquiring evaluation made by the observer for information expressing the state of the control target at a first time point and information expressing the state of the control target at a second time point different from the first time point; and
controlling the control target in accordance with a control parameter corresponding to a latent variable that matches a predetermined condition searched for in a latent space generated by dimensional compression of a plurality of pieces of information, the plurality of pieces of information being rated based on the evaluation.

12. The control method according to claim 11, comprising:
rating the state of the control target based on the evaluation, wherein
the controlling includes controlling the control target based on the rating.

13. The control method according to claim 11, wherein
the information represents an image or a moving image.

14. The control method according to claim 13, wherein
the control target is an apparatus for producing a material, and
the information represents an image related to the production of the material.

15. The control method according to claim 14, wherein
the information represents an image visualizing temperature and flow distributions of a raw material for producing the material.

16. The control method according to claim 15, wherein
the material is a SiC crystal, and
the controlling is to control at least one of the rotation speed of a seed crystal, the rotation speed of a crucible, the relative position of the crucible and a coil, the position of the coil, the level of a high-temperature liquid metal, the level of a meniscus of the high-temperature liquid metal, and a set temperature.

17. A control apparatus comprising circuitry configured to:
cause an observer by pairwise comparison to perceive information that expresses the state of a control target;
acquire evaluation made by the observer for information expressing the state of the control target at a first time point and information expressing the state of the control target at a second time point different from the first time point; and
control the control target in accordance with a control parameter corresponding to a latent variable that matches a predetermined condition searched for in a latent space generated by dimensional compression of a plurality of pieces of information, the plurality of pieces of information being rated based on the evaluation.

18. A non-transitory recording medium having embodied thereon a learning program comprising computer-implemented modules including:
a module that causes an observer to perceive a plurality of pieces of perceivable information by pairwise comparison;
a module that acquires evaluation for the information made by the observer;
a module that rates the plurality of pieces of information by a plurality of repetitions of the providing the information and the acquiring the evaluation;
a module that generates a latent space by dimensional compression of the plurality of pieces of information; and
a module that searches for a latent variable that matches a predetermined condition in the latent space.

19. A non-transitory recording medium having embodied thereon a control program comprising computer-implemented modules including:
a module that causes an observer by pairwise comparison to perceive information that expresses the state of a control target;
a module that acquires evaluation made by the observer for information expressing the state of the control target at a first time point and information expressing the state of the control target at a second time point different from the first time point; and
a module that controls the control target in accordance with a control parameter corresponding to a latent variable that matches a predetermined condition searched for in a latent space generated by dimensional compression of a plurality of pieces of information, the plurality of pieces of information being rated based on the evaluation.
